(19) United States
(12) Patent Application Publication
(10) Pub. No.: US 2014/0223648 A1
(43) Pub. Date: Aug. 14, 2014

(54) Exterior Facing Stretch and Flame Resistant Seam Tape

(71) Applicant: MASSIF MOUNTAIN GEAR COMPANY, Ashland, OR (US)

(72) Inventor: Michael Munter, Ashland, OR (US)

(73) Assignee: MASSIF MOUNTAIN GEAR COMPANY, Ashland, OR (US)

(21) Appl. No.: 13/766,834

(22) Filed: Feb. 14, 2013

(51) Int. Cl. A62B 17/00; B32B 33/00

(52) U.S. Cl. CPC A62B 17/003; B32B 33/00
USPC 2/455; 442/136

(57) ABSTRACT

A garment having at least two fabric substrates where the substrates are joined together at a seam over which a stretchable, exterior-facing seam tape is applied is provided. The seam tape includes a flame resistant fabric and a liquid barrier layer. The seam tape can further include a separate adhesive layer. The seam tape covers the seam and contacts an exterior surface of the first fabric substrate and an exterior surface of the second fabric substrate. Moreover, the seam tape can have stretch and exhibit similar properties to that of the two fabric substrates. Further, in one embodiment, the color and pattern of the seam tape matches the fabric substrates to which the seam tape is applied. Also described is a method for forming the seam tape and attaching the seam tape to a base fabric/seam.

### BACKGROUND

Flame resistant fabrics are used in numerous applications. In many environments, for instance, garments and apparel with flame resistant properties are highly desirable in order to protect the wearer. For example, military personnel operating in war zones can be exposed to various incendiary devices. Wearing flame resistant garments in such environments can minimize harm to the wearer and ultimately can prevent the loss of life.

In fact, the United States Military Services are currently providing those in combat zones with flame resistant garments to protect against burn injuries. Electrical workers, firefighters, police personnel, oil rig workers and many other occupations face similar burn threats on a regular basis while operating outside, often in inclement conditions. Although the garments are flame resistant, the level of fire protection provided to those wearing the garments would be compromised at the garment seams if traditional, non-flame resistant seam tapes were used, as such seam tapes could create a point of ignition on the garment upon coming into contact with a flame. Further, traditional seam tapes do not stretch, which can restrict the wearer's movement, leading to discomfort. In addition, traditional seam tapes are not generally matched to the garment, which is not aesthetically pleasing and can even put the garment wearer in harm's way when the garment is designed so that the wearer can blend in with his surroundings. Additionally, although some seam tapes have been used on interior seams to maintain a uniform appearance on the exterior fabric, this is not always feasible depending on the inner fabric layer, which can be fleece or a similar material to which a seam tape cannot easily adhere.

However, such seam tapes as described above are needed at the seams of garments to protect the wearer from the ingress or penetration of liquids when the wearer is exposed to the elements (e.g., rain, sleet, or snow), chemicals, biological fluids, and the like. For instance, the seam tapes may create a barrier against liquid penetration to prevent water and other fluids such as chemical and biological fluids from seeping through the garment to the wearer's skin. Unfortunately, because of the aforementioned limitations of existing, traditional seam tapes, a person wearing a garment having seams that have been constructed with such seam tapes must often compromise environmental protection, comfort, and the ability to blend in with their surroundings when they don a flame resistant garment having seams that are covered by traditional seam tape.

When two flame resistant fabrics are joined to form a garment, such as by sewing or bonding the two fabrics together, the seam renders the garment vulnerable to liquid penetration such that a sealant of some sort (e.g., a seam tape) must be utilized. While seam tapes have been utilized in an attempt to eliminate this problem, the seam tapes may not exhibit the same properties as the garment's base fabric, such as flame resistance and stretchability. Additionally, the seam tapes may not match the base fabrics used in forming the garment, which creates a noticeable discontinuity in the garment's appearance which may jeopardize the protective function of the garment (e.g., where the seam tape is a solid color while the base fabric has a camouflage pattern). Thus, a need exists for a stretchable seam tape exhibiting flame resistance that can act as a liquid barrier at a fabric seam, that has stretch, and that can be printed, dyed, or otherwise colored to match the base fabric(s). There is also a need for a method of producing the seam tape.

### SUMMARY OF THE INVENTION

In general, the present disclosure is directed to a garment comprising a first fabric substrate and a second fabric substrate joined together at a seam, over which a seam tape is applied. The seam tape is stretchable and flame resistant. More specifically, the seam tape comprises an outer-facing fabric substrate, wherein the outer-facing fabric substrate is flame resistant, as well as a liquid barrier layer. The seam tape covers the seam and contacts an exterior surface of the first fabric substrate and the second fabric substrate. The seam tape can further comprise an adhesive layer, wherein the adhesive layer has a melting temperature that is lower than a melting temperature of the liquid barrier layer. For instance, in one embodiment, the adhesive layer covers the seam and contacts an exterior surface of the first fabric substrate and an exterior surface of the second fabric substrate.

In one embodiment, the outer-facing fabric substrate can comprise inherently flame resistant fibers. In another embodiment, the inherently flame resistant fibers can comprise para-aramid fibers, meta-aramid fibers, polybenzimidazole fibers, or combinations thereof.

Meanwhile, in a still another embodiment, the outer-facing fabric substrate can comprise non-inherently flame resistant fibers. For instance, the outer-facing fabric substrate can comprise wool or any type of cellulosic fibers such as cotton, rayon, or combinations thereof. When the outer-facing fabric substrate comprises non-inherently flame resistant fibers, the outer-facing fabric substrate can be treated with a flame retardant such as a halogen-containing compound or a phosphorous-containing compound.

Further still, in one embodiment, an exterior surface of the outer-facing fabric substrate can be color matched to the first fabric substrate or the second fabric substrate. In yet another embodiment, a printed pattern can be visible on an exterior surface of the outer-facing fabric substrate, and the same printed pattern can be visible on the first fabric substrate or the second fabric substrate. For instance, the printed pattern can comprise a camouflage pattern.

In another embodiment, the liquid barrier layer can have a melting temperature ranging from about 65° C. to about 380° C. The liquid barrier layer can comprise any material having water barrier properties, such as a polyurethane, a fluoropolymer such as polytetrafluoroethylene or expanded polytetrafluoroethylene, a polyvinyl chloride, a silicone elastomer, or combinations thereof. Further, the liquid barrier layer can be flame resistant. The liquid barrier layer can also comprise a halogen-containing compound or a phosphorous-containing compound.

Meanwhile, the adhesive layer can comprise any suitable adhesive, such as a polyurethane adhesive, a polyamide adhesive, a nylon adhesive, a polyester adhesive, or combinations thereof. In one particular embodiment, the adhesive layer can have a melting temperature ranging from about 60° C. to about 225° C. In still another embodiment of the garment of the present disclosure, the first fabric substrate and the second fabric substrate can be flame resistant, no melt, and/or no drip. Generally, the seam tape in the garment can have a percent stretch ranging from about 0.5% to about 95%.

The present disclosure is also directed to a stretchable and flame resistant seam tape. The seam tape includes an outer-facing fabric substrate, wherein the outer-facing fabric substrate is flame resistant. The seam tape also comprises a liquid barrier layer. In another embodiment, the seam tape includes an adhesive layer, wherein the adhesive layer has a melting temperature that is lower than a melting temperature of the liquid barrier layer. Further, the liquid barrier layer can be flame resistant and can, for example, include a halogen-containing compound or a phosphorous-containing compound. The liquid barrier layer can have a melting temperature ranging from about 65° C. to about 380° C., and can include a polyurethane, a fluoropolymer, a polyvinyl chloride, a silicone elastomer, or combinations thereof. Meanwhile, the adhesive layer can have a melting temperature ranging from about 60° C. to about 225° C., and can include a polyurethane adhesive, a polyamide adhesive, a nylon adhesive, a polyester adhesive, or combinations thereof. Further, the seam tape can have a percent stretch ranging from about 0.5% to about 95%.

In addition, the present disclosure is also directed to a method of applying a seam tape to an exterior seam of a garment to create a liquid resistant and flame resistant seal. The method comprises applying a liquid barrier layer to an outer-facing fabric substrate, wherein the outer-facing fabric substrate is flame resistant, by a welding process. The method can further comprise applying an adhesive layer to the liquid barrier layer to form a three-layer seam tape, wherein the adhesive layer has a melting temperature that is lower than a melting temperature of the liquid barrier layer. The seam tape can then be applied to the seam. In one embodiment, the tape is applied to the seam by a hot air welding process.

In one embodiment, the hot air welding process can comprise heating the adhesive layer with a blast of hot air at a temperature ranging from about 250° C. to about 800° C., contacting the seam with the seam tape via the adhesive layer, and passing the seam with the seam tape applied thereto through rollers.

Other features and aspects of the present disclosure are discussed in greater detail below.

### BRIEF DESCRIPTION OF THE DRAWINGS

A full and enabling disclosure of the present disclosure, including the best mode thereof to one skilled in the art, is set forth more particularly in the remainder of the specification, including reference to the accompanying figures, in which:

FIG. 1 is a cross-sectional view of one embodiment of a seam tape made in accordance with the present disclosure;

FIG. 2 is a cross-sectional view of the seam tape illustrated in FIG. 1 when applied to a seam connecting two base fabric substrates; and

FIG. 3 is a top view of an embodiment of a seam tape as applied to a seam connecting two base fabric substrates and showing the color-matching characteristics of the seam tape.

Repeat use of reference characters in the present specification and drawings is intended to represent the same or analogous features or elements of the present disclosure.

### DETAILED DESCRIPTION

It is to be understood by one of ordinary skill in the art that the present discussion is a description of exemplary embodiments only, and is not intended as limiting the broader aspects of the present disclosure.

Generally, the present disclosure is directed to a garment having a fabric seam tape applied thereto that can that can enhance the stretchability, protective function and appearance of the garment while not jeopardizing its flame resistance. The seam tape of the present disclosure includes an outer-facing fabric substrate and a liquid barrier layer, and can further include a separate adhesive layer. Each layer of the seam tape is discussed in more detail below. Regardless of the construction, the seam tape can be applied to the exterior surface of the garment at a seam that connects a first base fabric substrate with a second base fabric substrate to provide a stretchable, liquid resistant, and flame resistant seam area that can be matched to the color and/or patterns of the first base fabric substrate, second base fabric substrate, or both.

### Outer-Facing Fabric Substrate

The outer-facing fabric substrate is the portion of the seam tape that is visible from the outside of a garment. The outer-facing fabric substrate can include multiple layers of one or more types of fabric, although this is not required. Generally, the outer-facing fabric substrate of the seam tape is flame resistant and has stretch. Further, the outer-facing fabric substrate can be color-matched to the first base fabric substrate and/or the second base fabric substrate. Further, the outer-facing fabric substrate can be made of the same material as the first base fabric substrate and/or the second base fabric substrate.

In any event, the outer-facing fabric of the seam tape can include any suitable type of fabric material. For instance, the fabric can include a stretch fabric. The stretch fabric can be a knitted fabric, woven fabric, a non-woven fabric, any other type of fabric, or combinations of these types of fabrics.

Further, the outer-facing fabric substrate may include synthetic fibers, natural fibers, or blends thereof. For example, in one embodiment, the outer-facing fabric can include synthetic fibers. In addition, the synthetic fibers can be inherently flame resistant. Examples of synthetic fibers that are inherently flame resistant include aramid fibers such as para-aramid fibers and meta-aramid fibers. One type of para-aramid fibers can include poly-para-phenylene terephthalamide, which is a wholly aromatic polymer with a very high thermal stability and flame resistance. While inherently flame resistant, para-aramid fibers can be ignited, although burning usually stops when the ignition source is removed. Para-aramid fibers do not melt, and no “drips” are experienced as with other organic fibers, which can reduce flame propagation. Meanwhile, one type of meta-aramid fibers can include meta aramid, poly(meta-phenyleneisophthalamide). This type of fiber has reduced chain rigidity as compared to the para orientation of para-aramid fibers which gives it more textile-like properties while maintaining the high temperature properties of para-aramid fibers. Meanwhile, polybenzimidazole (“PBI”) fibers are another type of inherently flame resistant synthetic fibers that can be used in the outer-facing fabric substrate of the described seam tape.

While the outer-facing fabric substrate can include inherently flame resistant fibers as discussed above, the outer-facing fabric substrate can also include non-inherently flame resistant synthetic or natural fibers that may or may not be treated with a flame retardant composition. For instance, if used alone, the non-inherently flame resistant fibers may be treated with a flame retardant composition, while if used in combination with an inherently flame resistant fiber, the non-inherently flame resistant fibers may or may not be treated with a flame retardant composition. As used herein, non-inherently flame resistant fibers are fibers made from materials that have a tendency to burn, melt and/or drip when subjected to an open flame.

Non-inherently flame resistant synthetic fibers may include non-aromatic polyamide (nylon) fibers, polyester fibers, polyolefin fibers such as polypropylene fibers, or mixtures thereof. Non-inherently flame resistant natural fibers may include cellulosic fibers such as cotton fibers or rayon. Other non-inherently flame resistant natural fibers can include wool fibers. Whether synthetic or natural non-inherently flame resistant fibers are used as part of the outer-facing fabric layer, they can be treated with a flame retardant composition to improve the overall flame resistant properties of the seam tape, whether such fibers are used in conjunction with inherently flame-resistant synthetic fibers or not.

As noted above, in one embodiment, the outer-facing fabric substrate of the seam tape can be treated with a flame retardant composition. Various flame retardant compositions can be used as part of the outer-facing fabric substrate of the seam tape. In one embodiment, a flame retardant composition may be impregnated into the outer-facing fabric substrate. Alternatively, a flame retardant composition may be coated onto the outer-facing fabric or may include a combination of coating and impregnation. Further, the flame retardant composition can be used to treat the entire outer-facing fabric substrate, one layer of the outer-facing fabric substrate, or the fibers that are used to produce the outer-facing fabric substrate. The particular flame retardant composition used in the present disclosure can vary depending upon the particular application and the desired result.

A variety of flame retardant compositions can be used for application to the outer-facing fabric substrate. In general, the flame retardant composition can include one or more flame retardants in combination with auxiliary chemicals or agents. The auxiliary chemicals or agents are used for applying the flame retardant to the outer-facing fabric substrate. The auxiliary agents may include, for instance, one or more carriers, solvents, or the like. In one embodiment, the flame retardant may be in the form of a solid that is dissolved or not dissolved in an aqueous or non-aqueous liquid. One or more flame retardants may be contained in the liquid carrier in amounts ranging from 0.5 to about 75% by weight, such as from about 10% to about 50% by weight. In general, the one or more flame retardants contained in the flame retardant composition are present in the composition and applied to the outer-facing fabric substrate in manners that completely saturate or apply as much as possible of the flame retardants to the outer-facing fabric substrate.

For example, the flame retardant composition can contain an elastic binder along with one or more flame retardants. In one embodiment, for example, the elastic binder in the flame resistant composition can be a natural or synthetic rubber. Synthetic rubbers that may be used include various butadiene polymers. Such materials include styrene butadiene rubber, butadiene rubber, acrylonitrile butadiene rubber, and the like. Other synthetic rubbers include isobutylene isoprene (butyl) rubber, ethylene propylene rubber, silicone rubber, and the like. In one embodiment, the elastic binder may comprise a block copolymer, such as a styrenic block copolymer. Such block copolymers include styrene-ethylene butylene-styrene block copolymers, styrene-isoprene-styrene block copolymers, styrene-butyl-styrene block copolymers, and the like.

In one particular embodiment, the synthetic rubber incorporated into the flame retardant composition can be polychloroprene, which is also referred to as poly(2-chloro-1,3-butadiene). Polychloroprene has been found to work particularly well with various flame retardant compounds. Polychloroprene also has good mechanical strength, good aging resistance, and has good adhesion properties with respect to fabric substrates. The polychloroprene, in one embodiment, can include a linear polymer. In various embodiments, a precrosslinked polychloroprene may be used as long as the binder is capable of being dissolved or dispersed in a solvent. In some embodiments, a sulfur-modified polychloroprene may be used.

In addition to an elastic binder, the flame retardant composition can also contain one or more flame retardant compounds. Flame retardants that can be used according to the present disclosure include inorganic flame retardants; halogenated flame retardants such as bromine and chlorine compounds; organophosphorus flame retardants such as phosphate esters; nitrogen-based organic flame retardants; metal-hydroxide flame retardants; melamine based flame retardants; borate-based flame retardants; and the like. Further, it should be understood that the aforementioned flame retardant compounds are examples only, and any suitable flame retardant compound can be used in the seam tape of the present disclosure.

Regardless of the particular flame retardant that may be used, the flame retardant composition can be applied to the non-inherently flame resistant synthetic or natural fibers discussed above, and it can also be applied to the inherently flame resistant fibers discussed above to form the outer-facing fabric substrate layer of the seam tape of the present disclosure.

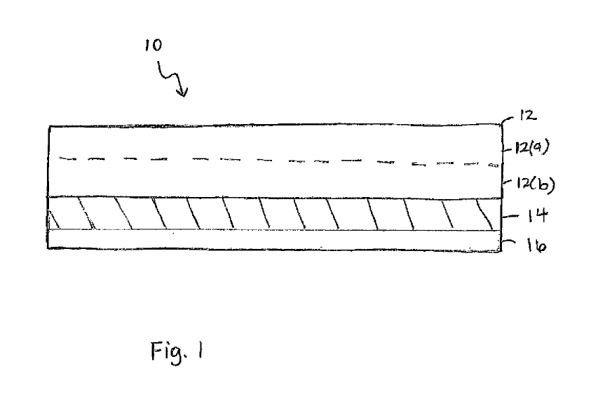

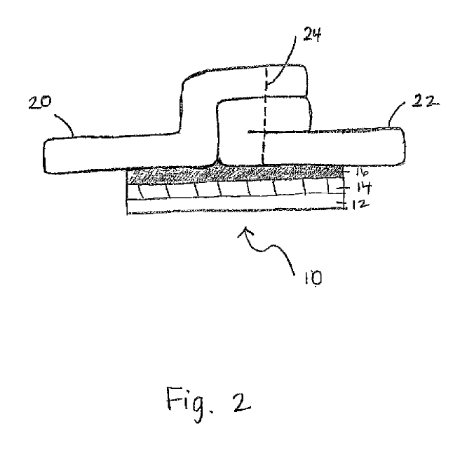

Referring to FIGS. 1 and 2, although the outer-facing fabric substrate 12 of the seam tape 10 can include one of inherently flame resistant synthetic fibers optionally treated with a flame retardant, non-inherently flame resistant synthetic fibers treated with a flame retardant, or non-inherently flame resistant natural fibers treated with a flame retardant, it is also to be understood that the outer-facing fabric substrate 12 can include layers or blends of synthetic, semi-synthetic, or natural fibers treated with a flame retardant and can further include blends of inherently flame resistant and non-inherently flame resistant fibers in any combination.

Referring now to FIG. 2, in one embodiment, for instance, the outer-facing fabric substrate 12 of the seam tape 10 can include a laminate containing a first outer-facing fabric substrate layer (e.g., the outermost-facing layer) 12(a) and a second outer-facing fabric substrate layer (e.g., the back layer) 12(b). Generally, the first outer-facing fabric substrate layer 12(a) of the laminate can include a fabric, such as a stretchable fabric, that contains primarily non-inherently flame resistant fibers. In one embodiment, for instance, the first outer-facing fabric substrate layer 12(a) includes polyester fibers, polyolefin fibers or nylon fibers (or a combination of these). The second outer-facing fabric substrate layer 12(b) of the outer-facing fabric substrate 12 can include the same or a different fabric in comparison to the first outer-facing fabric substrate layer 12(a). In one embodiment, the second outer-facing fabric substrate layer 12(b) can include a knitted fabric containing inherently flame resistant fibers, such as meta-aramid fibers. Although the first outer-facing fabric substrate layer 12(a) is described herein as non-inherently flame resistant, and the second outer-facing fabric substrate layer 12(b) is described as inherently flame resistant, these layers can be reversed. Further, in one embodiment, both layers 12(a) and 12(b) can be non-inherently flame resistant and treated with flame retardants. In still another embodiment, both layers 12(a) and 12(b) can be inherently flame resistant.

In yet another embodiment, the outer-facing fabric substrate 12 can have a plated knit construction where one type of yarn may appear on the outermost facing portion of the outer-facing fabric substrate 12 while another type of yarn may appear on the back of the outer-facing fabric substrate 12. For instance, non-inherently flame resistant fibers may form the outermost facing of the outer-facing fabric substrate 12 while inherently flame resistant fibers may form the back of the outer-facing fabric substrate 12. In yet another embodiment, the outermost facing portion of the outer-facing fabric substrate 12 can be a blend of non-inherently flame resistant fibers such as cotton fibers and inherently flame resistant fibers such as para-aramid, meta-aramid, or PSI fibers, while the back of the outer-facing fabric substrate 12 can be made of a blend of non-inherently flame resistant fibers.

Because the outer-facing fabric substrate 12 of the seam tape 10 of the present disclosure can have excellent flame resistant properties, the fabric is especially well-suited when constructing apparel and other similar articles designed to protect against the threat of a flash fire, an electric arc, or the like. In addition to having flame resistant properties due to the use of inherently flame resistant fibers and/or the use of non-inherently flame resistant properties treated with a flame retardant composition, the seam tape can also be designed to be liquid resistant (e.g., resistant to the elements such as rain, sleet, snow, etc. as well as chemicals and biological fluids) and stretchable. For instance, it is to be understood that regardless of the construction of the outer-facing fabric substrate 12 (for example, whether the outer-facing fabric substrate 12 of the seam tape 10 contains a single fiber type, is a blend or laminate, or has a plated knit construction), the outer-facing fabric substrate 12 of the seam tape 10 can be treated with other coatings or other treatments, such as finishes. In one embodiment, for instance, a durable water resistant coating may be applied to the outer-facing fabric 12 in conjunction with the flame retardant composition.

For example, the outer-facing fabric 12 of the seam tape 10 to the present disclosure may also undergo various treatments and finishing processes. In one embodiment, for instance, a durable water-repellent (DWR) treatment may be applied to the seam tape. Of particular advantage, the durable water-repellent treatment can be applied to the seam tape 10 without significantly adversely impacting upon the flame resistant properties of the product. In general, a durable water repellent treatment can include a coating or finish applied to the fabric product that is hydrophobic and that makes the product water-resistant. Examples of durable water-repellent treatments include silicone resin emulsions and various fluoropolymer-based treatments. Various additives suitable for imparting low surface tension fluid repellency to articles containing polymeric fibers are disclosed in U.S. Pat. No. 5,145,727, U.S. Pat. No. 5,178,931, U.S. Pat. No. 4,855,360, U.S. Pat. No. 4,863,983, U.S. Pat. No. 5,798,402, U.S. Pat. No. 5,459,188, and U.S. Pat. No. 5,025,052, which are all incorporated herein by reference.

Additionally, in one embodiment, in order to provide the seam tape 10 with stretch properties, the outer-facing fabric substrate 12 may contain elastic fibers such as elastane fibers. The elastic fibers can be incorporated into the outer-facing fabric in an amount from about 1% to about 30% by weight, such as in an amount from about 1% to about 15% by weight, such as in an amount from about 1% to about 5% by weight. The elastic fibers can provide the outer-facing fabric substrate 12 with stretch and recovery properties that can improve comfort and fit when the seam tape 10 is applied to a garment. In another embodiment, stretchability can be imparted to the outer-facing fabric substrate 12 via mechanical stretching of the starting fabric.

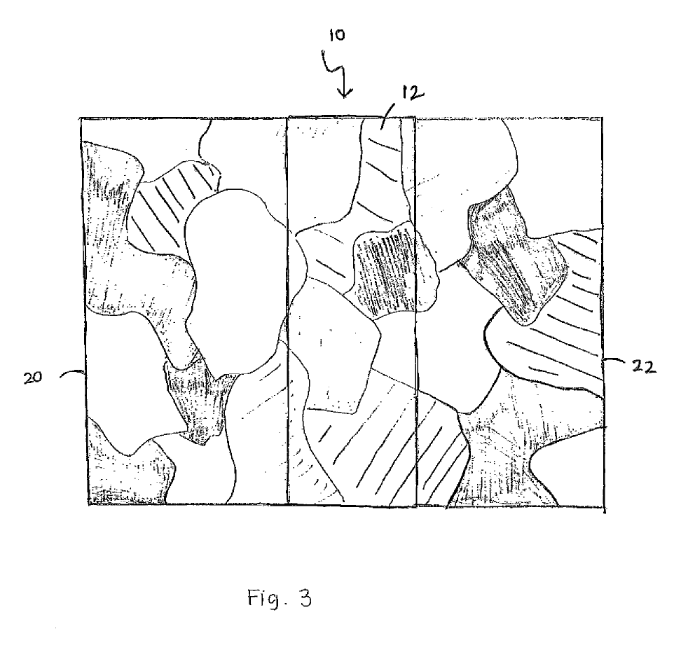

Further, in some embodiments, the outer-facing fabric substrate 12 can be dyed and/or printed. For instance, in the embodiment shown in FIG. 3, the outer-facing fabric substrate 12 of the seam tape 10 can first be dyed and then printed with a pattern, such as a camouflage pattern. The camouflage pattern, for instance, can have a 2 to 25 color scheme. However, it is also to be understood that the outer-facing fabric substrate 12 can have any other pattern, or can be any solid color. Regardless of the color or pattern of the outer-facing fabric substrate 12, it can match the underlying base fabric substrates 20 and 22 so that the seam tape blends in with and is not discernible from the underlying base fabric substrates. For example, as shown in FIG. 3, the outer-facing fabric substrate 12 can be dyed and/or printed so that it matches the color and or/pattern of the first base fabric substrate 20 and/or the second base fabric substrate 22 over which the seam tape 10 is applied.

Irrespective of the type of fabric, treatments applied, or flame resistant characteristics of the outer-facing fabric substrate of the seam tape of the present disclosure, the outer-facing fabric substrate can generally have any suitable basis weight depending upon the particular application and the desired result. For instance, the fabric can have a basis weight of from about 0.5 ounces per square yard (about 15 grams per square meter (gsm)) to about 20 ounces per square yard (about 675 gsm). In one embodiment, the fabric may have a relatively low basis weight, such as less than about 8 ounces per square yard (about 275 gsm). In one particular embodiment, the weight of the fabric can be from about 3 ounces per square yard (about 100 gsm) to about 7 ounces per square yard (about 240 gsm).

### Liquid Barrier Layer

Referring again to FIGS. 1 and 2, in addition to an outer-facing fabric substrate 12, the seam tape 10 according to the present disclosure also includes a liquid barrier layer 14 to protect the wearer from the penetration of any liquids such as rain, snow, sleet, chemicals, or biological fluids. The liquid barrier layer 14 can be applied to a surface of the outer-facing fabric substrate 12 using any suitable method. For example, the liquid barrier layer 14 can be applied to the back outer-facing fabric substrate 12 via lamination with heat and/or pressure, spray coating, floating knife coating, knife-over roll coating, or screen coating depending on the form of the liquid barrier layer 14 when it is applied.

Generally, the liquid barrier layer 14 can be formed from any liquid barrier material such as polyurethane, a fluoropolymer such as polytetrafluoroethylene and expanded polytetrafluoroethylene, a polyvinyl chloride, a silicone elastomer, or combinations thereof. The melting point of the liquid barrier layer 14 is higher than the melting point of the optional adhesive layer 16 discussed below. For example, the liquid barrier layer 14 can be a film or membrane have a melting temperature of from about 65° C. to about 380° C. in some embodiments, such as from about 70° C. to about 360° C. in other embodiments, and from about 80° C. to about 340° C. in still other embodiments.

In addition to rendering the garment liquid resistant at the seams as discussed above, the liquid barrier layer 14 of the seam tape 10 can also be flame resistant if desired. For instance, the liquid barrier layer 14 can include any of the flame resistant compositions described above in reference to the outer-facing fabric substrate 12. For example, the liquid barrier layer can include a flame resistant compound such as a halogen-containing compound or a phosphorous-containing compound. In one embodiment, the flame resistant compound can be incorporated into the urethane during the manufacturing process of the urethane. In this manner, the seam tape 10, via the liquid barrier layer, 14 can provide flame resistance to an area of a garment where the flame resistance may be compromised, in addition to the flame resistance that is already provided by the outer-facing fabric substrate 12.

When the liquid barrier layer includes a flame resistant compound, the flame resistant compound can be present in the liquid barrier layer in an amount of from about 5 wt. % to about 50 wt. %, such as from about 10 wt. % to about 40 wt. % in one embodiment, and such as from about 15 wt. % to about 30 wt. % in still another embodiment. Meanwhile, the liquid barrier layer can include from about 20 wt. % to about 95 wt. % of a liquid barrier material, such as from about 25 wt. % to about 90 wt. % in one embodiment, such as from about 30 wt. % to about 85 wt. % in still another embodiment.

Regardless of the specific composition of the liquid barrier layer 14, the liquid barrier layer 14 has a thickness ranging from about 10 micrometers to about 300 micrometers in some embodiments, from about 25 micrometers to about 250 micrometers in other embodiments, and from about 50 micrometers to about 200 micrometers in still other embodiments. Generally, however, the thickness of the liquid barrier layer 14 can be greater than that of the adhesive layer 16.

in one particular embodiment, the liquid barrier layer 14 of the seam tape 10 can be applied directly to a seam, where the seam joins together at least a first fabric substrate 20 and a second fabric substrate 22 to form a garment, although it is to be understood that a separate adhesive layer can also be used to adhere the seam tape to a seam, as discussed below.

### Adhesive Layer

The seam tape 10 can also contain a separate adhesive layer 16, as shown in FIGS. 1-2. The adhesive layer 16 can be applied to a surface of the liquid barrier layer 14 using any suitable method, such as lamination by heat and/or pressure, spray coating, floating knife coating, knife-over roll coating, or screen coating. The adhesive layer can be a polyurethane-based adhesive, a polyamide-based adhesive, a nylon-based adhesive, a polyester-based adhesive, or combinations thereof. Generally, the adhesive layer can be used to adhere the seam tape to two or more fabric substrates joined at a seam.

It is not required that the adhesive layer 16 be flame resistant, although it can be if desired and can include any of the flame resistant compositions described above in reference to the outer-facing fabric substrate 12 or liquid barrier layer 14. The adhesive layer 16 is the point of contact between the seam tape 10 and the first fabric substrate 20 and/or second fabric substrate 22 at seam 24. The melting point of the adhesive layer 16 is lower than the melting point of the liquid barrier layer 14 discussed above so that the adhesive layer 14 can be heated to at or near its melting temperature to adhere the seam tape 10 to the fabric substrates 20 and/or 22 at seam 24 without disrupting the integrity of the liquid barrier layer 14 or the outer-facing fabric substrate 12. For example, the adhesive layer 16 can be a film or membrane having a melting temperature of from about 60° C. to about 225° C. in some embodiments, such as from about 65° C. to about 200° C. in other embodiments, and from about 70° C. to about 175° C. in still other embodiments.

Regardless of the specific composition of the adhesive layer 16, the adhesive layer 16 has a thickness ranging from about 25 micrometers to about 250 micrometers in some embodiments, from about 50 micrometers to about 200 micrometers in other embodiments, and from about 75 micrometers to about 150 micrometers in still other embodiments. Generally, however, the thickness of the adhesive layer 16 can be less than that of the liquid barrier layer 14.

### Garment First and Second Fabric Substrates

The seam tape 10 including the outer-facing fabric substrate, the liquid barrier layer, and the adhesive layer can be applied to a seam, where the seam joins together at least a first fabric substrate 20 and a second fabric substrate 22 to form a garment, as shown in FIG. 3. The garment can be in the form of a shirt, jacket, pants, hat, gloves, or any garment having seams. Further, the first and second fabric substrates can be made of any suitable fabric, such as those described above in reference to the outer-facing fabric substrate of the seam tape. In one embodiment, the first and second fabric substrates can be a solid color, and the outer-facing fabric substrate 12 of the seam tape 10 can have the same solid color. In another embodiment, the first and second fabric substrates can be dyed and then printed with a pattern, such as a camouflage pattern, as shown in FIG. 3. The camouflage pattern, for instance, may have a 2 to 25 color scheme, and can be the same as the outer-facing fabric substrate 12 of the seam tape 10.

### Method of Forming Seam Tape and Adhering to Garment Seam

The seam tape comprising the outer-facing fabric substrate 12, which can further include a first outer-facing fabric substrate layer (outer-most facing layer) 12(a) and a second outer-facing fabric substrate layer (back layer) 12(b); the liquid barrier layer 14; and the adhesive layer 16 can be formed by any suitable method such as laminating, welding, calendering, coating, or spraying. For instance, pressure and heat can be used to laminate the liquid barrier layer 14 to the outer-facing fabric substrate, and then the adhesive layer 16 can be laminated onto the liquid barrier layer 14. In another embodiment, the adhesive layer 16 can be sprayed onto the liquid barrier layer 14. The resulting overall thickness of the seam tape 10 including all three layers can range from about 100 micrometers to about 1250 micrometers in some embodiments, such as from about 200 micrometers to about 1000 micrometers in other embodiments, such as from about 300 micrometers to about 750 micrometers in still other embodiments. Meanwhile, seam tape 10 can be cut so that the width of the seam tape can range from about 5 millimeters (mm) to about 50 mm in some embodiments, from about 10 mm to about 40 mm in other embodiments, and from about 15 mm to about 30 mm in still other embodiments.

As shown in FIG. 3, regardless of the method by which the three-layer seam tape 10 is constructed, after the seam tape 10 is formed, the seam tape 10 can be applied to a fabric seam 24 to render the seam liquid resistant and flame resistant. Further, after the seam tape 10 is applied to a seam 24, the area over which the seam tape 10 is applied can have the same stretchability as the base fabric substrate(s) and can be color-matched to the base fabric substrate(s) because the outer-facing fabric substrate layer can be formed from the same fabric as the base fabric substrates.

Any suitable process can be used to adhere the seam tape 10 over the seam 24 and edges of the first and second base fabric substrates 20 and 22, such as by hot air welding, thermowelding, heat pressing, ultrasonic welding, or RF welding. For example, a hot air welder or sealer can be used. With hot air welding, heated air is blown into the seam area. A roller and the weight of the machine then presses together the seam tape 10 over the seam 24 and first and second base fabric substrates 20 and 22. As the welder moves away from the seam area, the membrane quickly cools down to ambient temperature and the heat weld is completed, providing a watertight, permanent bond. Generally, the temperature at which the hot air is applied can range from about 250° C. to about 800° C. in some embodiments, from about 300° C. to about 750° C. in other embodiments, and from about 350° C. to about 700° C. in still other embodiments. Meanwhile, the air can be applied to the seam tape 10/seam area at with the tape moving at a rate of from about 2 meters/minute (m/min) to about 10 m/min in some embodiments, from about 3 m/min to about 9 m/min in other embodiments, and from about 4 m/min to about 8 m/min in still other embodiments. Further, the pressure at which the hot air can be applied to the seam tape 10 on the side of the adhesive layer 16 can range from about 50 kilopascals (kPA) to about 200 kPa in some embodiments, such as from about 75 kPa to about 150 kPa in other embodiments, such as from about 100 kPa to about 125 kPa in still other embodiments. After being heated via the hot air, the seam tape 10 can then be passed through rollers along with the first and second base fabric substrates 20 and 22 joined by seam 24 so that the seam tape 10 can adhere to the seam area. The pressure at the rollers can range from about 200 kPa to about 500 kPa in some embodiments, from about 250 kPa to about 450 kPa in other embodiments, and from about 300 kPa to about 400 kPa in still other embodiments. After passing through the rollers, the seam tape covered fabric is allowed to cool.

Generally, the resulting seam tape, regardless of the method by which it is formed, can have a percent stretch of up to about 100%, such as from about 0.5% to about 95% in one embodiment, such as from about 0.75% to about 85% in another embodiment, such as from about 1.0% to 75% in yet another embodiment. Moreover, the seam tape made according to the present disclosure as discussed above can be used to form numerous different types of articles and products. In one embodiment, for instance, the seam tape can be used to make apparel and other garments. Such apparel can include jackets, shirts, coats, pants, bib overhauls, gloves, hats, face shields, socks, shoes, boots, and any other apparel or garments having seams. The seam tape can be applied to seams on any type of clothing.

### Testing

In order to determine the stretch and recovery of the seam tape, two ASTM Test Methods were followed, namely ASTM Test Method D3107 and ASTM Test Method D2594. Results from ASTM Test Method D3107 and ASTM Test Method D2594 are shown below.

TABLE 1
ASTM D3107 - Fill Direction

| Test | Tension | Time | Percent (%) |
|---|---|---|---|
| Stretch¹ | 4 lbs. | 10 seconds | 1.3 |
| Stretch¹ | 4 lbs. | 30 minutes | 1.3 |
| Growth | 0 lbs. | 1 hour | 0.0 |
| Recovery | 4 lbs. | 30 seconds | 1.3 |

¹Note:
1.75 lbs. per 7/8″ width seam tape; long dimension of tape is fabric length

TABLE 2
ASTM D2594- Length Direction

| Test | Tension | Time | Percent (%) |
|---|---|---|---|
| Stretch, Loose Fit¹ | 5 lbs. | — | 0.6 |
| Recovery, Loose Fit | — | 1 minute | 58.3 |
| Recovery, Loose Fit | — | 60 minutes | 70.8 |

¹Note:
0.875 lbs. per 7/8″ width seam tape

These and other modifications and variations to the present disclosure may be practiced by those of ordinary skill in the art, without departing from the spirit and scope of the present disclosure, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. A garment comprising:
a first fabric substrate and a second fabric substrate, wherein the first fabric substrate and the second fabric substrate are joined together at a seam;
a stretchable and flame resistant seam tape, the seam tape comprising:
an outer-facing fabric substrate, wherein the outer-facing fabric substrate is flame resistant; and
a liquid barrier layer, wherein the seam tape covers the seam and contacts an exterior surface of the first fabric substrate and an exterior surface of the second fabric substrate.

2. The garment of claim 1, further comprising:
an adhesive layer, wherein the adhesive layer has a melting temperature that is lower than a melting temperature of the liquid barrier layer, and further wherein the adhesive layer covers the seam and contacts an exterior surface of the first fabric substrate and an exterior surface of the second fabric substrate.

3. The garment of claim 1, wherein the outer-facing fabric substrate comprises inherently flame resistant fibers.

4. The garment of claim 3, wherein the inherently flame resistant fibers comprise para-aramid fibers, meta-aramid fibers, polybenzimidazole fibers, or combinations thereof.

5. The garment of claim 1, wherein the outer-facing fabric substrate comprises non-inherently flame resistant fibers.

6. The garment of claim 5, wherein the outer-facing fabric substrate is treated with a flame retardant.

7. The garment of claim 6, wherein the flame retardant comprises a halogen-containing compound or a phosphorous-containing compound.

8. The garment of claim 1, wherein an exterior surface of the outer-facing fabric substrate is printed or dyed to match the first fabric substrate or the second fabric substrate.

9. The garment of claim 1, wherein a printed pattern is visible on an exterior surface of the outer-facing fabric substrate, further wherein the same printed pattern is visible on the first fabric substrate or the second fabric substrate.

10. The garment of claim 9, wherein the printed pattern comprises a camouflage pattern.

11. The garment of claim 1, wherein the liquid barrier layer has a melting temperature ranging from about 65° C. to about 380° C.

12. The garment of claim 1, wherein the liquid barrier layer comprises a polyurethane, a fluoropolymer, a polyvinyl chloride, a silicone elastomer, or combinations thereof.

13. The garment of claim 1, wherein the liquid barrier layer is flame resistant.

14. The garment of claim 13, wherein the liquid barrier layer comprises a halogen-containing compound or a phosphorous-containing compound.

15. The garment of claim 2, wherein the adhesive layer has a melting temperature ranging from about 60° C. to about 225° C.

16. The garment of claim 2, wherein the adhesive layer comprises a polyurethane adhesive, a polyamide adhesive, a nylon adhesive, a polyester adhesive, or combinations thereof.

17. The garment of claim 1, wherein the first fabric substrate and the second fabric substrate are flame resistant.

18. The garment of claim 1, wherein the seam tape has a percent stretch ranging from about 0.5% to about 95%.

19. A stretchable and flame resistant seam tape, the seam tape comprising:
an outer-facing fabric substrate, wherein the outer-facing fabric substrate is flame resistant; and
a liquid barrier layer.

20. The seam tape of claim 19, wherein the seam tape further comprises an adhesive layer, wherein the adhesive layer has a melting temperature that is lower than a melting temperature of the liquid barrier layer.

21. The seam tape of claim 19, wherein the liquid barrier layer is flame resistant.

22. The seam tape of claim 19, wherein the liquid barrier layer has a melting temperature ranging from about 65° C. to about 380° C., and further wherein the liquid barrier layer comprises a polyurethane, a fluoropolymer, a polyvinyl chloride, a silicone elastomer, or combinations thereof.

23. The seam tape of claim 20 wherein the adhesive layer has a melting temperature ranging from about 60° C. to about 225° C., and further wherein the adhesive layer comprises a polyurethane adhesive, a polyimide adhesive, a nylon adhesive, a polyester adhesive, or combinations thereof.

24. The seam tape of claim 19, wherein the seam tape has a percent stretch ranging from about 0.5% to about 95%.

25. A method of applying a seam tape to an exterior seam of a garment to create a liquid resistant and flame resistant seal, the method comprising:
applying a liquid barrier layer to an outer-facing fabric substrate, wherein the outer-facing fabric substrate is flame resistant, to form a multi-layered, stretchable seam tape; and
applying the seam tape to the seam by a welding process.

26. The method of claim 25, further comprising applying an adhesive layer to the liquid barrier layer to form a three-layer seam tape, wherein the adhesive layer has a melting temperature that is lower than a melting temperature of the liquid barrier layer, prior to applying the seam tape to the seam.

27. The method of claim 26, wherein the seam tape is applied to the seam by a hot air welding process.

28. The method of claim 27, wherein the hot air welding process comprises heating the adhesive layer with a blast of hot air at a temperature ranging from about 250° C. to about 800° C., contacting the seam with the seam tape via the adhesive layer, and passing the seam with the seam tape applied thereto through rollers.
